(19) United States
(12) Patent Application Publication
(10) Pub. No.: US 2022/0119030 A1
(43) Pub. Date: Apr. 21, 2022

(54) MODULABLE SLED

(71) Applicant: DECATHLON, Villeneuve d'Ascq (FR)

(72) Inventors: Octavien MAILLARD, Villeneuve d'Ascq (FR); Jean-Baptiste BONNAFOUS, Villeneuve d'Ascq (FR); Thomas BOUSCH, Villeneuve d'Ascq (FR)

(21) Appl. No.: 17/501,243

(22) Filed: Oct. 14, 2021

(30) Foreign Application Priority Data
Oct. 19, 2020 (FR) 2010717

(51) Int. Cl. B62B 17/06

(52) U.S. Cl. CPC B62B 17/06

(57) ABSTRACT

The invention relates to a modulable sled comprising a shell having an outer slide structure and an inner seating structure for at least one user. The seating structure has two lateral walls each extending vertically on either side of the seat. The sled has a brake device which is actuated by at least one handle mounted on one of the lateral walls. The sled also includes a module having an alternative seating structure, with the module being arranged to be able to be reversibly mounted in the shell by covering its seating structure and creating an alternative seating configuration on the sled. The module also has at least one lateral structure which, when it is mounted in the shell, is arranged to prevent the actuation of the handle of the brake device.

### CROSS-REFERENCE TO RELATED APPLICATION

This application claims the priority of French patent application number 2010717, filed on Oct. 19, 2020, the entire contents of which are incorporated herein by reference.

### TECHNICAL FIELD

The invention relates to a modulable sled, as well as a set comprising such a modulable sled and a second sled.

### BACKGROUND

In particular, it applies to sleds intended for practicing a recreational activity, in particular to enable at least one user to slide on a snowy terrain.

For this purpose, sleds comprising a shell that has an outer slide structure and an inner seating structure for at least one user are known.

To prevent snow from penetrating into the shell during the use thereof, the seating structure has two lateral walls each extending vertically on either side of a seat of said seating structure, as well as two respectively front and rear walls each having a free edge which is raised with respect to the slide structure.

Advantageously, the shell may be made in one piece by injection and moulding of a thermoplastic material, which allows facilitating the manufacture thereof, and therefore reducing its cost, but also producing a sled with a reduced weight, which facilitates the use and transport thereof, in particular by a child.

To enable a user occupying the seat to control his/her movements, the sled comprises a brake device which is actuated by at least one handle mounted on one of the lateral walls. In particular, sleds with a brake device equipped with two actuating handles each mounted on respectively one lateral wall are known, the user selectively actuating at least one of said handles to perform a braking.

Moreover, to enable a user to haul the sled on the ground, in particular when another user occupies the seat, the front wall is equipped with a means for associating a rope or a strap. Thus, an adult could use the sled to initiate a child to sliding activities.

In general, these sleds have a seat whose dimensions are not suited for young children, in particular for babies. Thus, during the use of the sled, the risk of the child falling off the shell is considerable. Moreover, a young child could inadvertently actuate the braking handles, which makes the use of these sleds tedious.

The document FR-2 004 396 proposes a sled that has a shell as described before, as well as a module that could be reversibly mounted in said shell to confer a seating configuration thereon enabling a user to keep his/her legs in a bent or stretched position.

This solution does not provide satisfaction, as it allows neither adapting the seat of a sled to a young child, nor preventing said child from actuating braking handles of a sled.

### SUMMARY

The invention aims at improving the prior art by proposing in particular a modulable sled that could be easily and selectively adapted to the size and/or the age of a user, in particular to an adult or a young child.

To this end, according to a first aspect, the invention proposes a modulable sled comprising a shell having an outer slide structure and an inner seating structure for at least one user, said seating structure having two lateral walls each extending vertically on either side of a seat of said seating structure, said sled further comprising a brake device which is actuated by at least one handle mounted on one of the lateral walls, said sled comprising a module having an alternative seating structure, said module being arranged so as to be able to be reversibly mounted in the shell by covering its seating structure in order to confer an alternative seating configuration on said sled, said module comprising at least one lateral structure which, when it is mounted in the shell, is arranged so as to prevent the actuation of the handle of the brake device.

According to a second aspect, the invention proposes a set comprising such a modulable sled and a second sled comprising a second shell, the module being arranged so as to be able to be reversibly mounted in any one of the shells so as to confer an alternative seating configuration thereon.

### BRIEF DESCRIPTION OF THE DRAWINGS

Other particularities and advantages of the invention will appear in the following description, made with reference to the appended figures, wherein:

FIG. 1 schematically represents, in a side view, the stack of the shells and of the module of a set according to the invention;

FIG. 2 represents, in a perspective top view, the three elements composing the set of FIG. 1;

Each of FIGS. 3a, 3b and 3c represents the set of FIG. 1 with its different elements stacked on one another, in a sectional view respectively according to a longitudinal vertical plane (FIG. 3a), the transverse vertical plane X-X of FIG. 3a (FIG. 3b) and the transverse vertical plane Y-Y of FIG. 3a (FIG. 3c);

FIGS. 4a, 4b, 4c and 4d represent, in a perspective front view, different steps of mounting the module on one of the shells of the set of the previous figures.

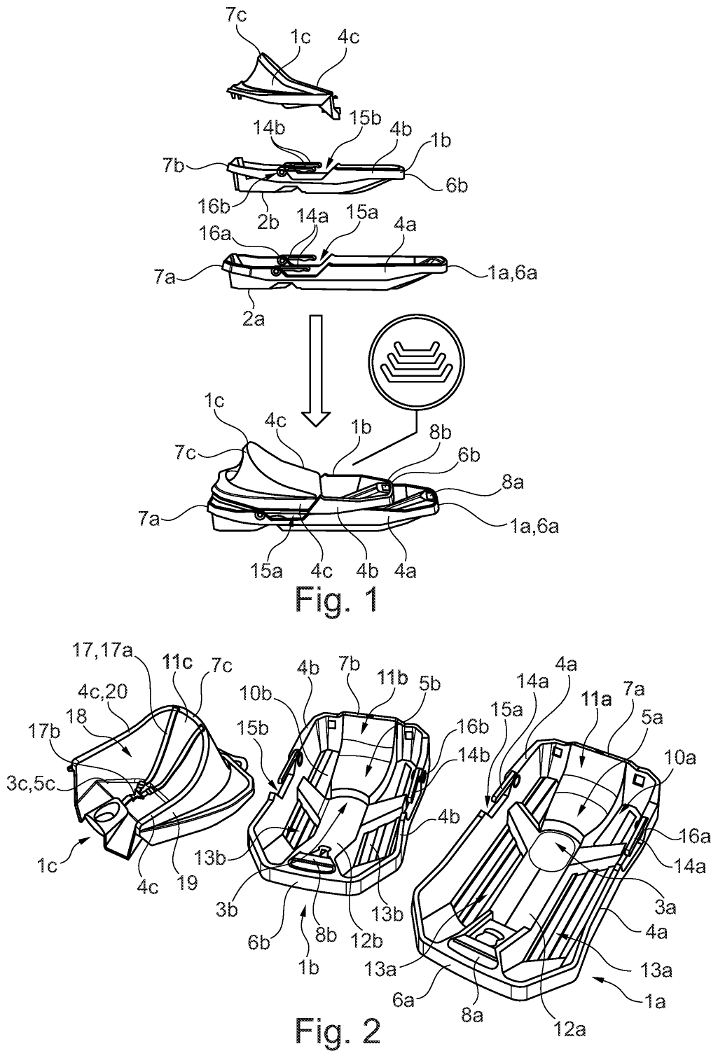

### DETAILED DESCRIPTION

With reference to these figures, a modulable sled, as well as a set comprising such a modulable sled and a second sled, are described hereinbelow.

The sleds respectively comprise first and second shells 1a, 1b, each shell 1a, 1b having an outer slide structure 2a, 2b, suited in particular for a snowy terrain, and an inner seating structure 3a, 3b for at least one user.

Advantageously, the shells 1a, 1 b have identical shape and arrangement, and differ only by their dimensions, thereby enabling them to receive a different number of users at once and/or users of different sizes and/or ages.

In the represented embodiment, the set thus comprises a first sled with a shell 1a suited for an adult, and a second sled with a shell 1b having smaller dimensions, suited in particular for a child or a teenager.

Each shell 1a, 1b is made in one piece, in particular by injection and moulding of a thermoplastic material. In the figures, both shells 1a, 1b have a substantially rectangular shape, in particular symmetrical with respect to a longitudinal vertical plane.

To prevent snow from penetrating into the shell 1a, 1b during the use thereof, each seating structure 3a, 3b has two lateral walls 4a, 4b each extending vertically on either side of a seat 5a, 5b of said seating structure, as well as two respectively front 6a, 6b and rear 7a, 7b walls each having a free edge which is raised with respect to the slide structure 2a, 2b.

As represented in the figures, the rear wall 7a, 7b extends substantially vertically at the rear of the seating structure 3a, 3b. Furthermore, the front wall 6a, 6b extends along a substantially oblique direction from a front edge of the seating structure 3a, 3b, in order to form a leading edge to facilitate the movements of the sled on a snowy terrain.

The front wall 6a, 6b is also equipped with a means 8a, 8b for enabling a manual gripping of the sled and/or fastening of a rope or a strap on said sled, in order to enable a user to haul said sled on a snowy terrain, in particular with another user occupying the seating structure 3a, 3b.

Advantageously, the second shell 1b has a geometry arranged so as to enable stacking thereof on the first shell 1a when the set is not used, which allows limiting the bulk thereof, and thus facilitating the storage and transport thereof, in particular in a vehicle boot.

In particular, the second shell 1b is arranged so as to enable, during stacking thereof on the first shell 1a, the arrangement of the second seating structure 3b on top of the first seating structure 3a.

For this purpose, with reference to FIGS. 3b and 3c, the lateral walls 4b of the second shell 1b are arranged so as to vertically bear on at least two areas 9 respectively on a lateral wall 4a of the first shell 1a, in order to stabilise the stacking thereof.

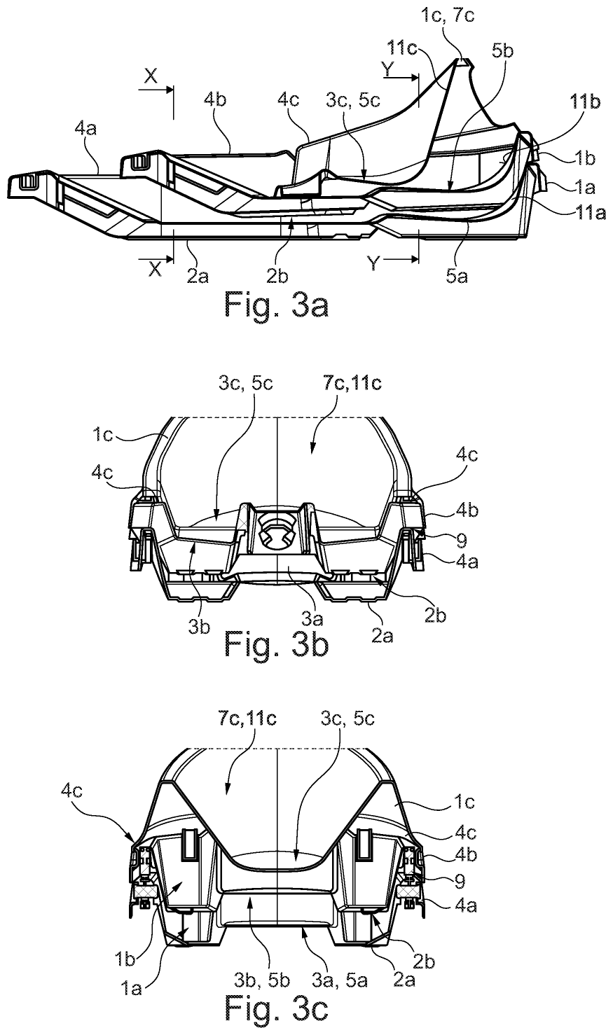

As represented in particular in FIG. 2, each of the seating structures 3a, 3b is formed in relief in their respective shell 1a, 1b. In particular, each shell 1a, 1b comprises a bottom 10a, 10b on which the seating structure 3a, 3b is formed in relief, and underneath which the outer slide structure 2a, 2b is formed.

The seating structure 3a, 3b comprises a rear seat 5a, 5b formed in relief on the bottom 10a, 10b, and the rear wall 7a, 7b has a vertical structure in relief forming a backrest 11a, 11b for said seat. Moreover, the seating structure 3a, 3b comprises a central platform 12a, 12b extending longitudinally between a front edge of the seat 5a, 5b and the upper edge of the front wall 6a, 6b, two locations 13a, 13b being formed on either side of said platform to respectively receive one leg of the user.

To enable a user occupying the seat 5a, 5b to control his/her movements, each sled comprises a brake device which is actuated by at least one handle 14a, 14b mounted on one of the lateral walls 4a, 4b. In the figures, each of the sleds comprises a brake device which comprises two actuating handles 14a, 14b each mounted respectively on one lateral wall 4a, 4b of said sled, the user selectively actuating at least one of said handles to perform a braking.

Each lateral wall 4a, 4b comprises a recess 15a, 15b which is formed on its upper edge, said recess comprising a rear bearing surface 16a, 16b on which a braking handle 14a, 14b is mounted.

The sled further comprises a module 1c having an alternative seating structure 3c, suited in particular for a young child and/or a baby, said module being arranged so as to be able to be reversibly mounted in a shell 1a, 1b covering its seating structure 3a, 3b, in order to confer an alternative seating configuration on said sled.

Thus, a slide set that could be used by a child throughout his/her growth is obtained. In particular, the module 1c is arranged so as to be able to be reversibly mounted in any one of the first and second shells 1a, 1b to confer an alternative seating configuration thereon.

To prevent a young child occupying the sled from inadvertently actuating the brake device 14a, 14b, in particular when another user hauls said sled on the ground, the module 1c comprises at least one lateral structure 4c which, when it is mounted in a shell 1a, 1b, is arranged so as to prevent the actuation of a braking handle 14a, 14b of said shell.

In the represented embodiment, the module 1c comprises two lateral structures 4c each arranged so as to prevent the actuation of respectively one braking handle 14a, 14b during mounting thereof on one of the shells 1a, 1b.

The alternative seating structure 3c is formed in relief in the module 1c. In particular, the module 1c comprises a wall 7c extending substantially vertically at the rear of its seating structure 3c, and in particular in the peripheral continuation of each of the lateral structures 4c, said rear wall further forming a backrest 11c for the seat 5c of said seating structure.

To limit the risk of a young child falling off the sled, the module 1c comprises a safety harness 17 to attach the user occupying the alternative seating structure 3c.

In the figures, the harness 17 comprises:
two slings 17a each having an upper end fastened at the upper portion of the backrest 11c, and a lower end equipped with a reversible fastening means;
a loop 17b fastened at the front of the seat 5c, and arranged so as to receive the reversible fastening means of each sling 17a during the use of said harness.

Each lateral structure 4c comprises two respectively inner 18 and outer 19 walls extending vertically while being connected by an upper wall 20, said walls being arranged so as to cover a handle 14a, 14b during mounting of the module 1c in a shell 1a, 1b.

Advantageously, the walls 18, 19, 20 are arranged so as to enable the lateral structures 4c to lie in the peripheral continuation of the lateral walls 4a, 4b of a shell 1a, 1b during mounting of the module 1c in said shell. Such an arrangement allows improving the aesthetic aspect of the sled, but also avoiding the formation of protrusions against which a user could cling and/or be hit.

The module 1c comprises reversible fastening means arranged so as to cooperate with complementary means formed on the shells 1a, 1b during mounting of the module 1c in one of said shells.

One amongst the fastening means and the complementary means may comprise at least one snap-fitting tab 21, 22, in particular integral with the module 1c or the shell 1a, 1b, the other one amongst said fastening means and said complementary means comprising an orifice 23, 24 for receiving said tab.

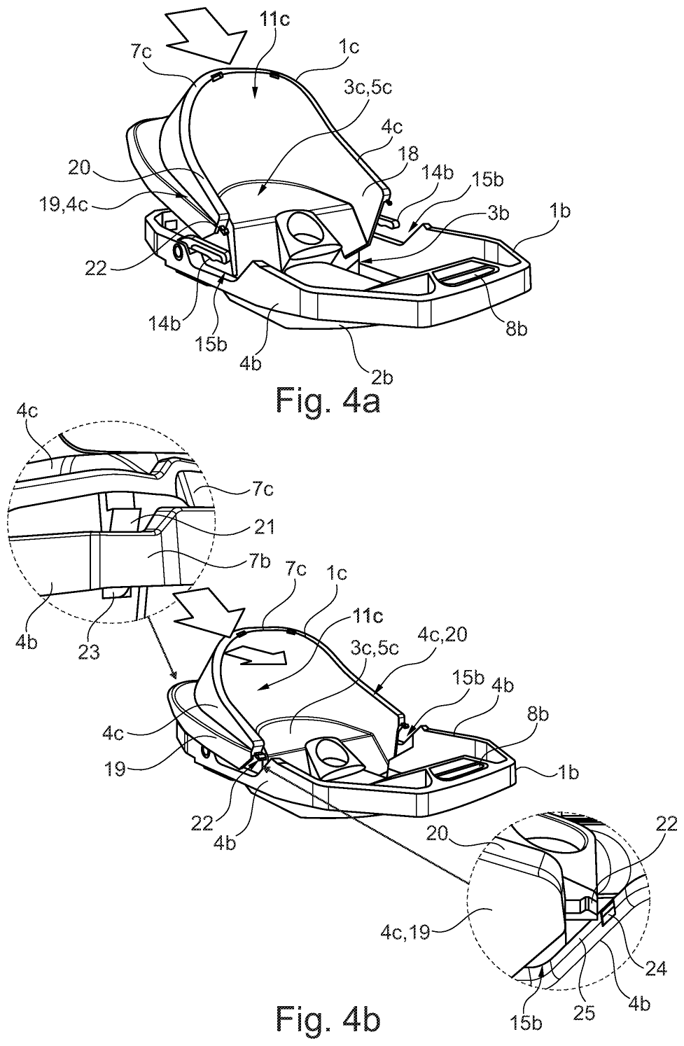

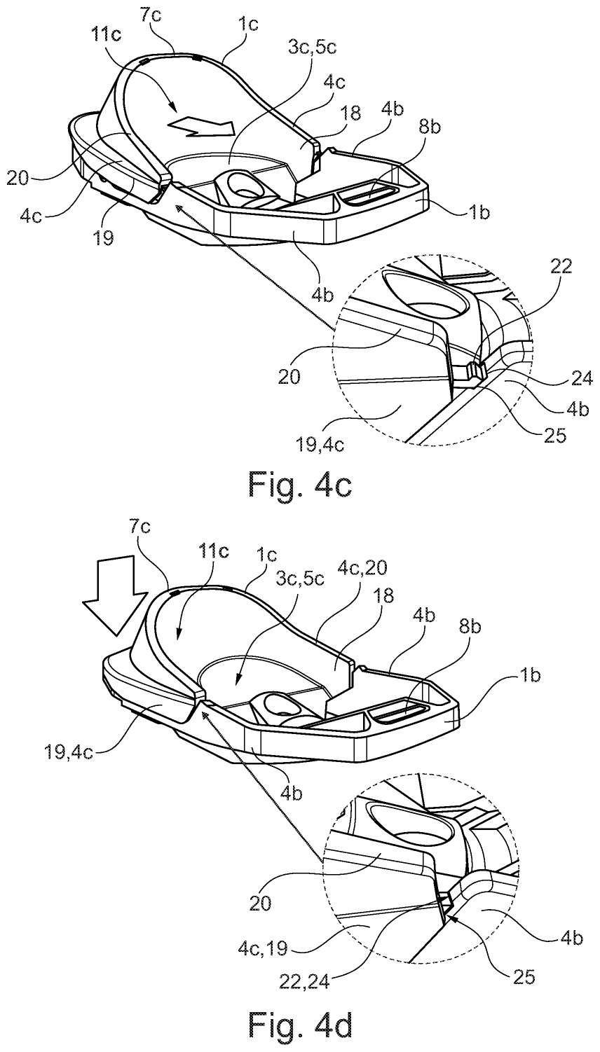

With reference to FIGS. 4a, 4b, 4c and 4d, mounting of the module 1c on the shell 1b suited for a child or a teenager is described. While not represented, the module 1c may also be mounted on the shell 1a suited for an adult, said shell for an adult having for this purpose fastening or complementary means similar to those of the shell 1b for a child or a teenager.

In FIG. 4b, the module 1c and the shell 1b respectively comprise fastening means and complementary means formed at the rear of their respective seating structure 3b, 3c.

In particular, as represented in the enlarged view at the top left of this same figure, the module 1c comprises a snap-fitting tab 21 formed underneath a lower edge of its rear wall 7c, the shell 1b comprising an orifice 23 formed on an upper edge of the rear wall 7b and arranged so as to receive said tab.

Advantageously, the module 1c may comprise two snap-fitting tabs 21 as described hereinabove, and the shell 1b may comprise two orifices 23 formed on either side of the backrest 11b and arranged so as to respectively receive one of said tabs. Alternatively, possibly complementarily, each of the module 1c and the shell 1b has, in particular at their rear wall 7b, 7c, an orifice throughout which a strap is tightened in order to secure fastening thereof.

As represented in the enlarged views of FIGS. 4b, 4c and 4d, each of the lateral structures 4c comprises a front end equipped with a snap-fitting tab 22, in particular integral with said structure. Moreover, each of the lateral walls 4b of the shell 1b has a complementary orifice 24 formed on a front bearing surface 25 of the recess 15b, each of the tabs 22 being arranged so as to cooperate with the orifice 24 of the corresponding lateral wall 4b during mounting of the module 1c in the shell 1b.

To mount the module 1c in the shell 1b, the user first places said module on top of said shell, so as to place the alternative seating structure 3c on top of the seat 5b of said shell, and the snap-fitting tabs 21, 22 opposite their respective mounting orifices 23, 24 (FIGS. 4a, 4b).

Afterwards, to complete the mounting, the user should successively:
make the module 1c slide slightly forwards, in order to fit each front tab 22 into its corresponding orifice 24 (FIG. 4c); and
fold the rear wall 7c of the module 1c down on the rear wall 7b of the shell 1b, in order to fit the rear tab(s) 21 into the rear orifice(s) 23 (FIG. 4d).

What is claimed is:

1. A modulable sled comprising a shell having an outer slide structure and an inner seating structure for at least one user, the inner seating structure having two lateral walls each extending vertically on either side of a seat of the seating structure, a brake device which is actuated by at least one handle mounted on one of the lateral walls, a module with a seating structure, the module configured to be reversibly mounted in the shell by covering the inner seating structure in order to confer an alternative seating configuration on the sled, the module comprising at least one lateral structure which, when it is mounted in the shell, is configured to prevent the actuation of the handle of the brake device.

2. The modulable sled according to claim 1, wherein the brake device comprises two actuating handles each actuating handle mounted on a different lateral wall, the module comprising two lateral structures each arranged to prevent the actuation of respectively one handle when said module is mounted in the shell.

3. The modulable sled according to claim 1, wherein the module comprises reversible fasteners configured to cooperate with complementary orifices formed on the shell during mounting of said module in said shell.

4. The modulable sled according to claim 3, wherein the lateral structure comprises a front end having with reversible fasteners, the reversible fasteners configured to cooperate with complementary orifices formed on the corresponding lateral wall during mounting of the module in the shell.

5. The modulable sled according to claim 3, wherein the module and the shell respectively comprise reversible fasteners and complementary orifices formed at the rear of their inner seating structure.

6. The modulable sled according to claim 3, wherein the fastener comprises a snap-fitting tab and the complementary orifice comprises an orifice for receiving said tab.

7. The modulable sled according to claim 1, wherein each of the module and the shell has an orifice throughout which a strap is tightened in order to secure fastening thereof.

8. The modulable sled according to claim 1, wherein each of the seating structure and the alternative seating structure is formed in relief in the shell and the module respectively.

9. The modulable sled according to claim 8, wherein each of the module and the shell comprises a rear wall extending substantially vertically at the rear of their respective seating structure, said rear wall forming a backrest for the seat of said seating structure.

10. The modulable sled according to claim 1, wherein the module comprises a safety harness for attaching a user occupying the seating structure.

11. The modulable sled according to claim 1, wherein the lateral structure comprises two respectively inner and outer walls extending vertically while being connected by an upper wall, said walls being configured to cover the handle during mounting of the module in the shell.

12. The modulable sled according to claim 1, wherein the lateral structure of the module is configured to lie in the peripheral continuation of the lateral wall of the shell during mounting of said module in said shell.

13. A set comprising a modulable sled according to claim 1, and a second sled comprising a second shell, the module configured to be able to be reversibly mounted in any one of the shells to confer an alternative seating configuration thereon.

14. The set according to claim 13, wherein the second shell has an inner seating structure and two lateral walls each extending on either side of the seat of the seating structure, as well as a brake device actuated by at least one handle mounted on one of the lateral walls, the module being configured to prevent the actuation of the handle during mounting thereof in the second shell.

15. The set according to claim 13, wherein the second shell has a geometry arranged to enable stacking thereof on the first shell when said set is not used.

16. The set according to claim 15, wherein the second shell is configured during stacking thereof on the first shell, the arrangement of the second seating structure above the first seating structure.
